(19) United States
(12) Patent Application Publication
(10) Pub. No.: US 2002/0093280 A1
(43) Pub. Date: Jul. 18, 2002

(54) Compact ballast for fluorescent lamps

(76) Inventor: Ayoub Rezai Hariri, (US)

Correspondence Address: Enrique G. Estevez, Allen, Dyer, Doppelt, Milbrath & Gilchrist, P.A., 255 South Orange Avenue, Suite 1401, P.O. Box 3791, Orlando, FL, 32802-3791, US

(21) Appl. No.: 10/039,513

(22) Filed: Oct. 26, 2001

(30) Foreign Application Priority Data
Oct. 26, 2000 (IR) 26726

(51) Int. Cl. H01J 5/48; H01J 5/50

(52) U.S. Cl. 313/318.01

(57) ABSTRACT

An apparatus and method for compact ballast for fluorescent lamps includes a housing having an upper end, a lower end, and a side periphery extending therebetween; a threaded base extending from the lower end of the housing and comprising a plurality of base electrical contacts insulated from each other for connecting the ballast to a complementary source of electrical power; a plurality of armature windings connected in series to the plurality of base electrical contacts to thereby provide voltage and current sufficient for heating electrodes in the fluorescent lamp when the lamp is electrically connected to the ballast; and a lamp receptacle formed at the upper end of the housing and including a plurality of receptacle contacts connected to the plurality of armature windings and to the plurality of base electrical contacts so as to complete an electrical circuit with a fluorescent lamp engaged in the lamp receptacle, the lamp receptacle having a receptacle cavity extending into the housing from the upper end toward the lower end, and having the plurality of armature windings positioned about a periphery of the receptacle cavity to thereby provide compactness to the ballast.

### RELATED APPLICATION

This application claims priority from Invention Registration No. 26726, which application was filed on Oct. 26, 2000 in the Islamic Republic of Iran, and which is incorporated herein by reference in its entirety.

### FIELD OF THE INVENTION

The present invention relates to the field of fluorescent lighting and, more particularly, to a compact ballast for low power fluorescent lamps.

### BACKGROUND OF THE INVENTION

The increasing cost of electricity is of concern not only in many developing countries, but also in the industrialized world. Recently skyrocketing costs for electrical power in some parts of the U.S. have brought new emphasis on energy saving measures. Low power fluorescent lamps which employ from about 5 to 30 watts provide one means for helping to reduce usage of electrical power. For example, such low power fluorescent lamps have gained popularity in developing countries due to circumstances affecting the electrical power infrastructure of the country, and the high cost of electricity therein.

### SUMMARY OF THE INVENTION

With the foregoing in mind, the present invention advantageously provides an inductive ballast which can be economically manufactured, which is compact in size, and which includes a lamp socket positioned within the ballast cavity so as to accept a fluorescent lamp therein and contributing to the small, compact size of the lighting fixture.

The present ballast design is particularly well suited for use with fluorescent lamps made to hang from the fixture in the manner of a standard incandescent lightbulb. The invention is also useful for connecting a low wattage fluorescent light bulb to a standard socket normally used with an incandescent bulb.

The ballast preferably comprises from two to four component members arranged so as to form a lamp socket therebetween. Two to four armature windings, or coils, are included in the ballast, and these are connected together in series. The ballast is manufactured to meet standards IEC 901, IEC 920 and IEC 921, so as to produce heat within acceptable limits.

### BRIEF DESCRIPTION OF THE DRAWINGS

Some of the features, advantages, and benefits of the present invention having been stated, others will become apparent as the description proceeds when taken in conjunction with the accompanying drawings in which:

FIG. 1 includes a side elevation (1A) of the ballast, and a top plan view (1B) of same, according to an embodiment of the present invention;

FIG. 2 is a partial cross section of the ballast of FIG. 1A;

FIG. 3 shows the ballast of FIG. 2 in partial cross section turned about 90° therefrom;

FIG. 4 is a top plan view of the ballast of FIG. 2;

FIG. 5 shows a partial cross section of the lower end of the housing for the ballast of FIG. 2;

FIG. 6 illustrates a bottom plan cross section cut along lines A-A of FIG. 5;

FIG. 7 is another view of the bottom plan cross section shown in FIG. 6 showing cut lines B-B;

FIG. 8 is a partial side elevation shown in cross section along lines B-B of FIG. 7;

FIG. 9 shows a top plan view of the ballast of FIG. 1;

FIG. 10 is a cross section cut along lines A-A of FIG. 9; and

FIG. 11 shows a cross section cut along lines B-B of FIG. 9.

### DETAILED DESCRIPTION OF THE PREFERRED EMBODIMENT

The present invention will now be described more fully hereinafter with reference to the accompanying drawings, in which preferred embodiments of the invention are shown. This invention may, however, be embodied in many different forms and should not be construed as limited to the illustrated embodiments set forth herein. Rather, these illustrated embodiments are provided so that this disclosure will be thorough and complete, and will fully convey the scope of the invention to those skilled in the art.

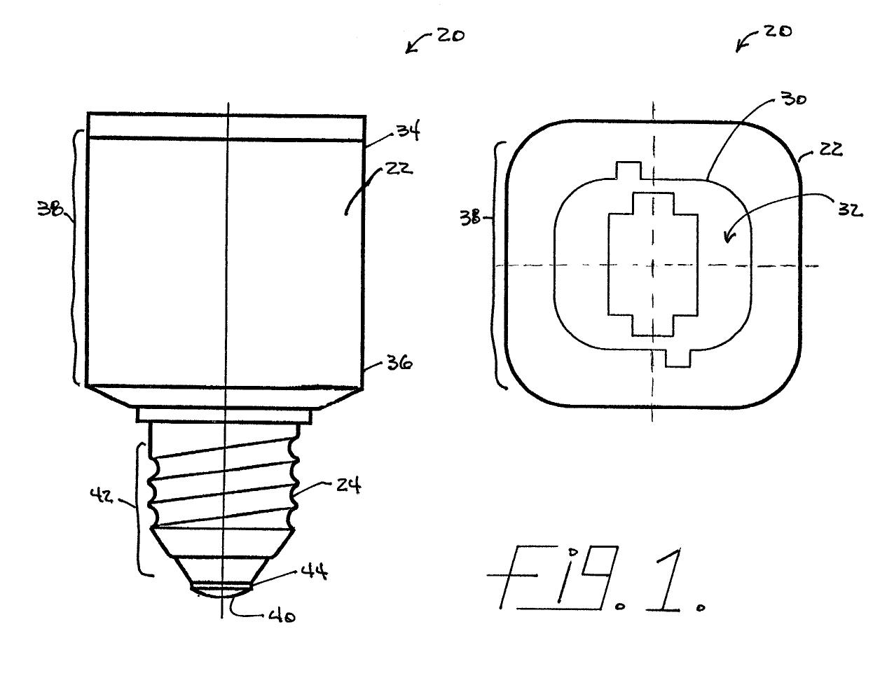

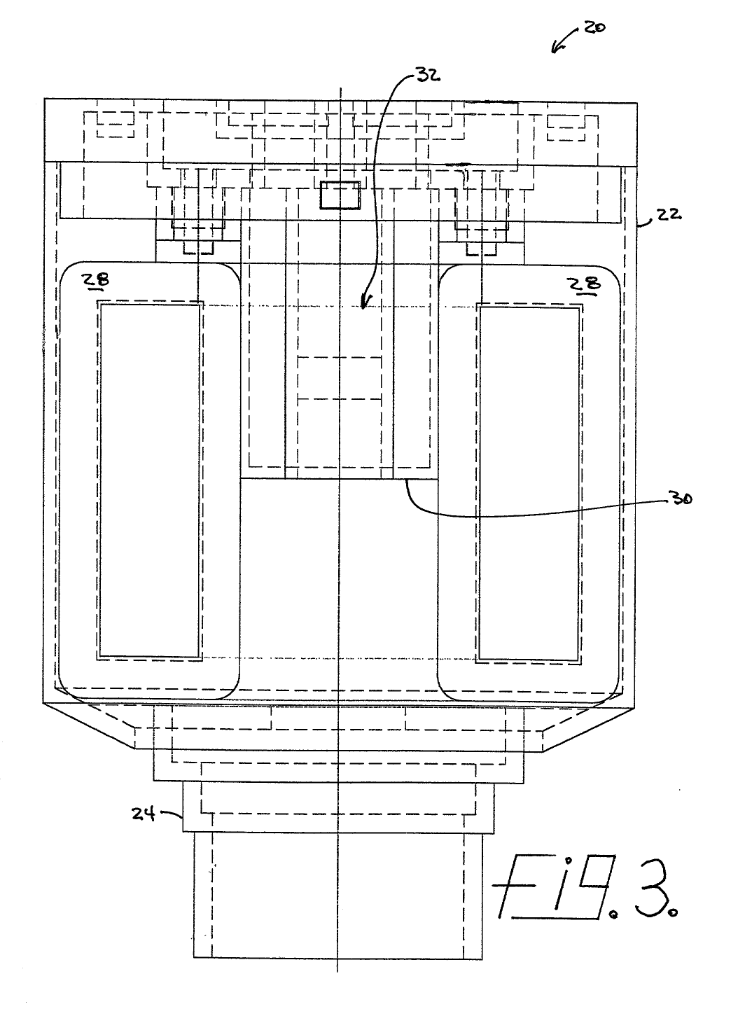

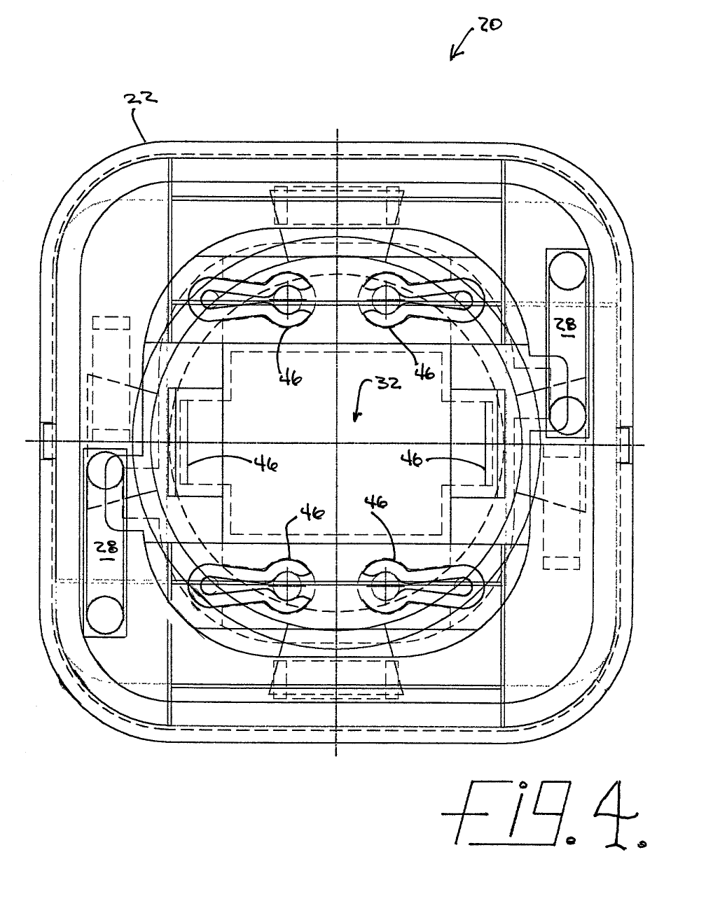

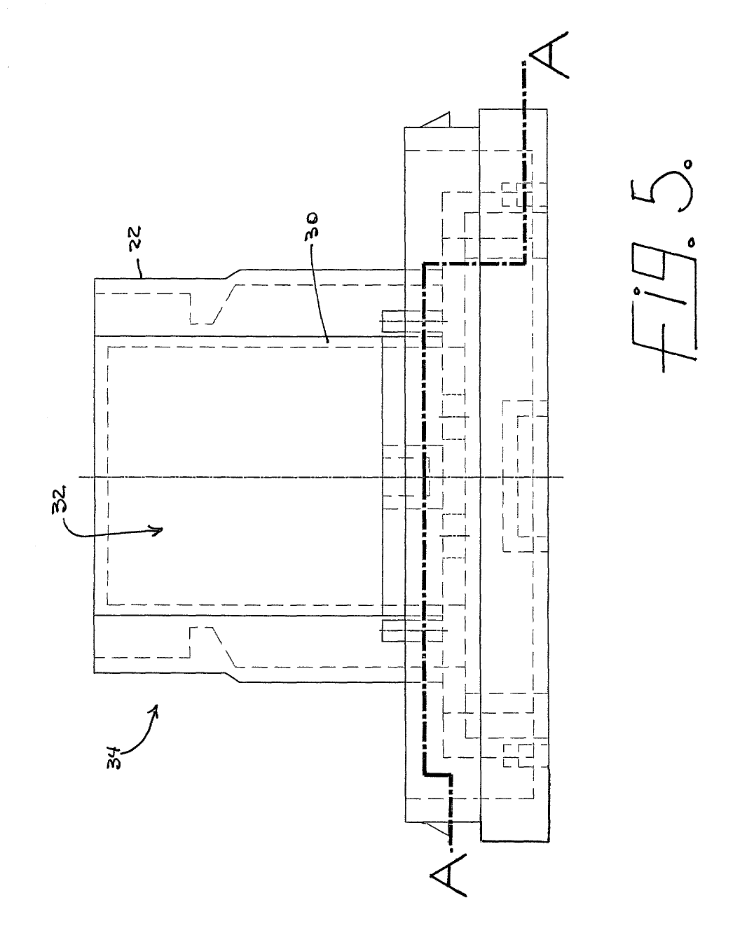

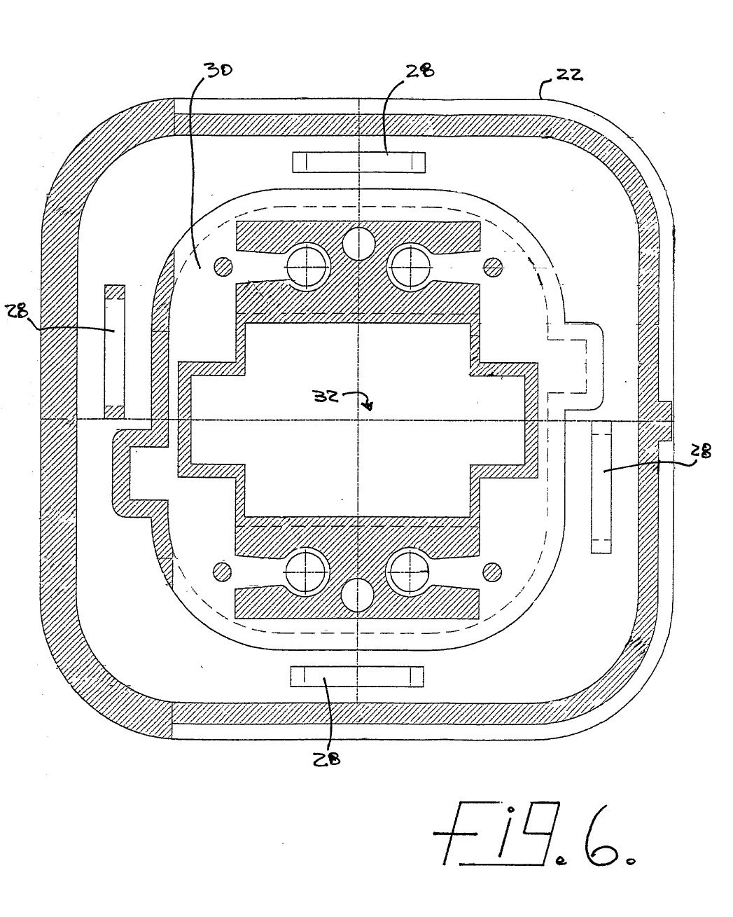

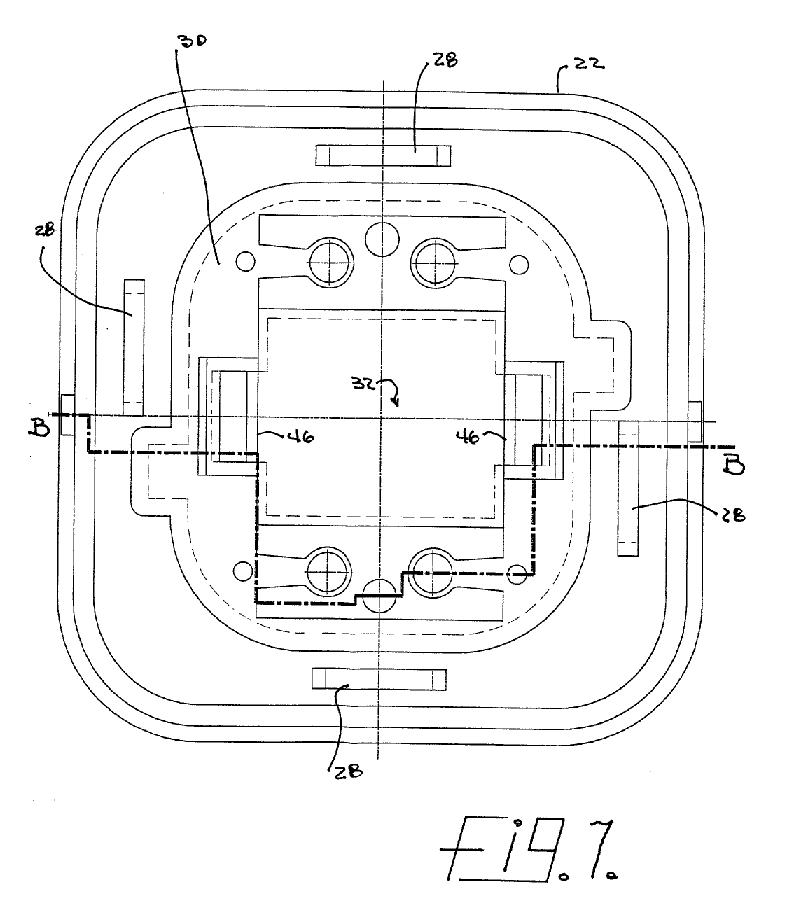

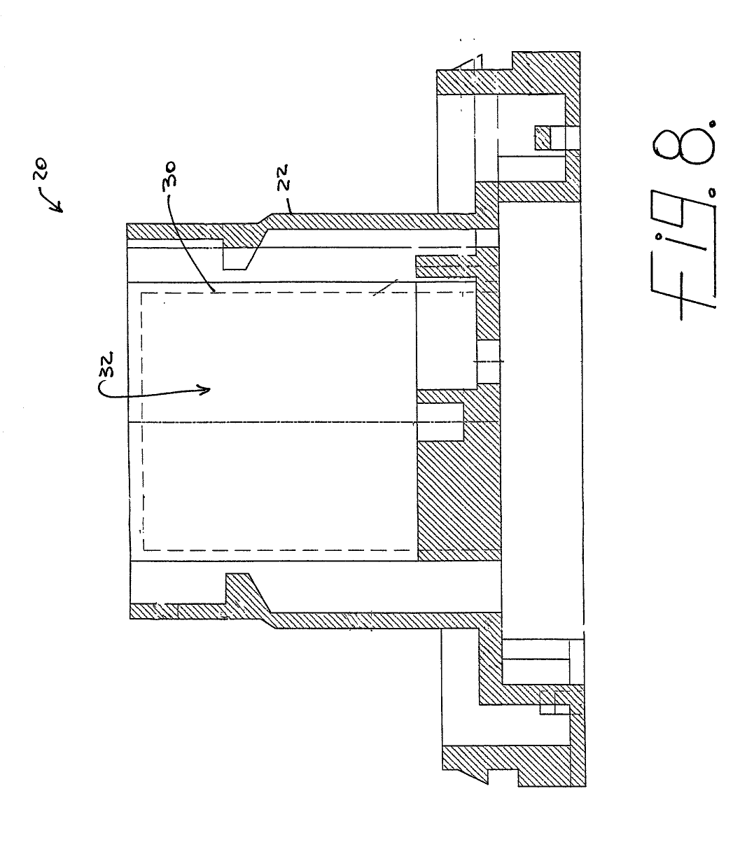

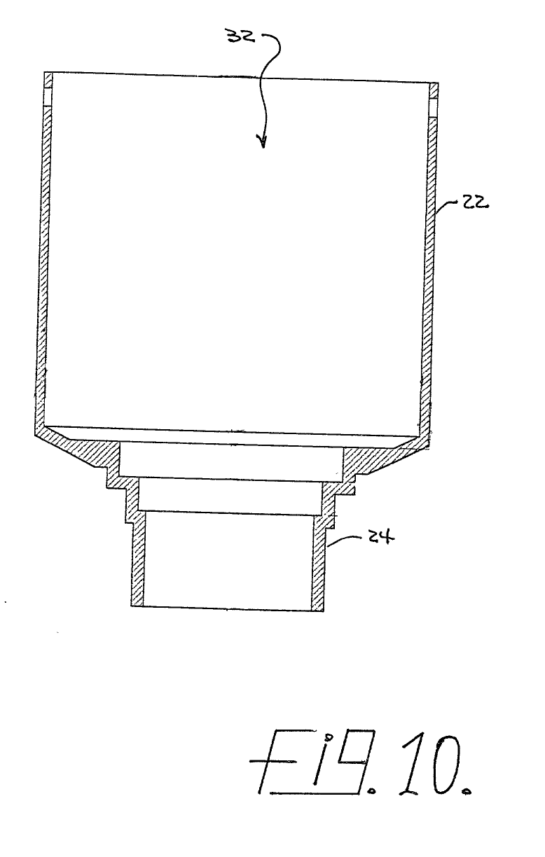

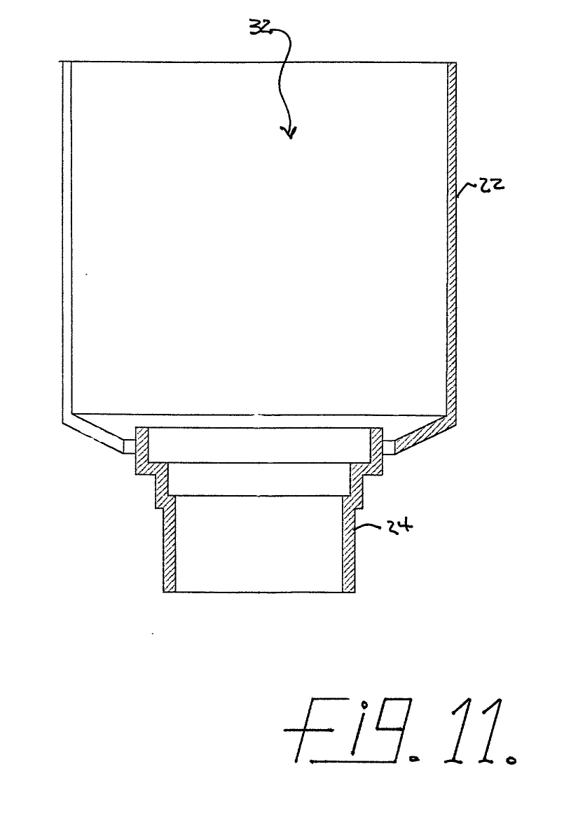

FIGS. 1 through 11 illustrate a ballast 20 for use with a low wattage fluorescent lamp, particularly with a compact lamp having an internal starter. The ballast 20 for a fluorescent lamp comprises a housing 22, a threaded base 24 having base electrical contacts 26, at least two armature windings 28, and a lamp receptacle 30 for receiving the fluorescent lamp therein. The ballast 20 is structured so that the lamp connects into a receptacle cavity 32 formed within the housing 22, or body of the ballast.

The housing 22 has an upper end 34, a lower end 36, and a side periphery 38 extending therebetween, as shown in FIGS. 1-3, 5, 8, and 10-11. The periphery of the housing 22 preferably forms a generally square outline, as shown in FIG. 1B. Those skilled in the art will recognize that the housing 22 is preferably fabricated of a weather and heat resistant plastic material, and that the outer shape of the ballast 20 device may be varied according to need or desire. The upper end 34 of the housing 22 includes a lamp receptacle 30, and the lower end 36 of the housing comprises a base 24 for electrically connecting the ballast 20 to a source of power.

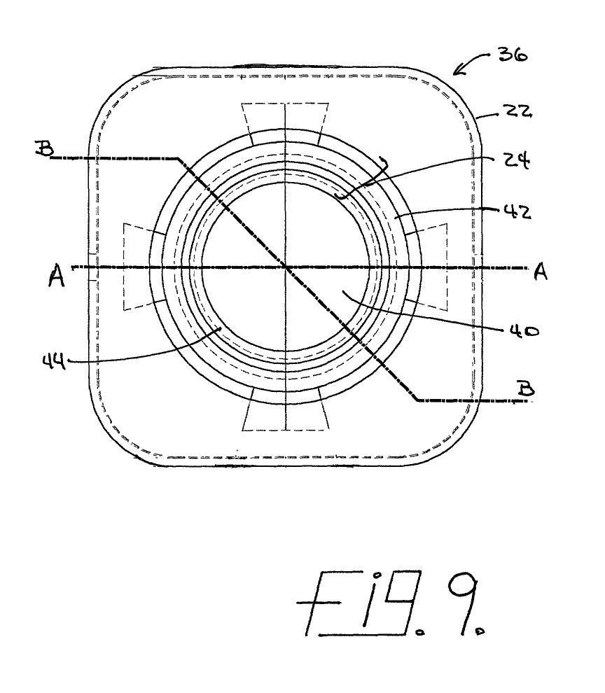

The preferably threaded base 24 extends from the lower end 36 of the housing 22, as best shown in FIGS. 1A, and 9. The base 24 comprises two base electrical contacts 40, 42 separated from each other by an insulator 44 and which serve to connect the ballast 20 to a complementary source of electrical power. The base 24 is preferably threaded and generally of the type known in the art for use with incandescent light bulbs, that is, a standard threaded base for connecting into a threaded lamp socket.

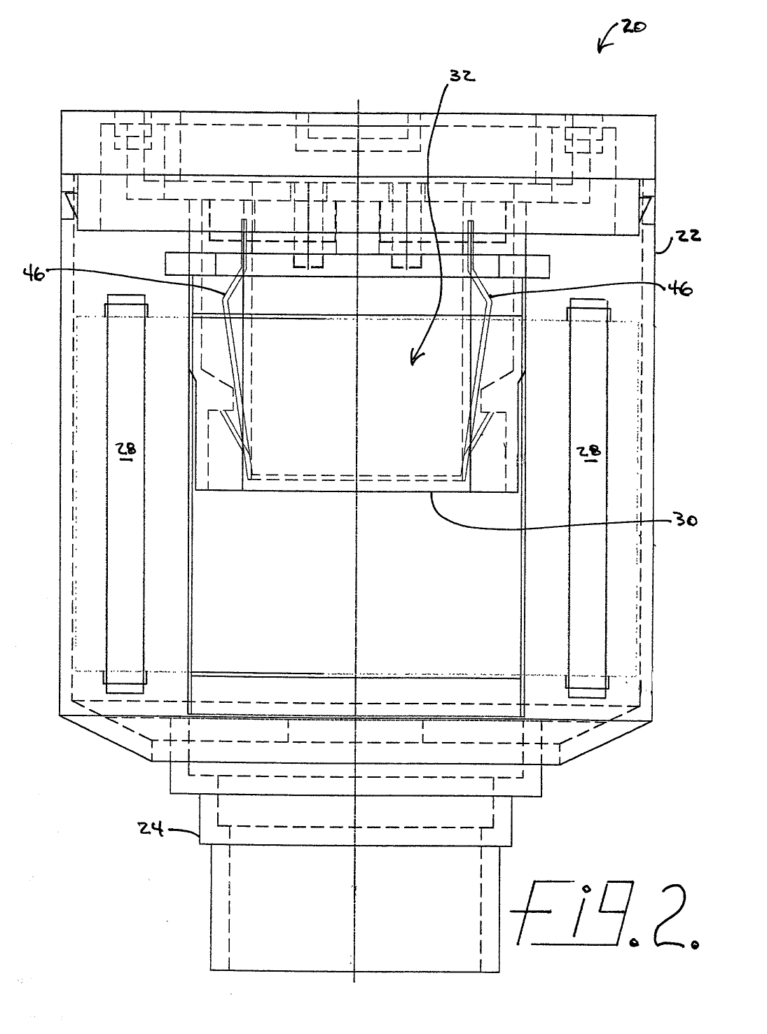

At least two armature windings 28, as shown in FIGS. 2-4, 6, and 7, are connected in series to one of the base electrical contacts 40, 42 to thereby provide voltage and current sufficient for heating the electrodes in a fluorescent lamp connected into the lamp receptacle 30 of the ballast 20. Alternatively, the ballast 20 may include four such armature windings 28.

A lamp receptacle cavity 32 is formed at the upper end 34 of the housing 22 and includes at least two receptacle contacts 46 connected to the armature windings 28 and to the base electrical contacts 40, 42 so as to properly complete an electrical circuit with a fluorescent lamp engaged in the lamp receptacle 30. The lamp receptacle 30 has a receptacle cavity 32 which extends into the housing 22 from the upper end 34 toward the lower end 36, and which has the two armature windings 28 positioned about a periphery of the receptacle cavity 32 to thereby provide compactness to the ballast 20 device. As noted above, an alternate embodiment of the ballast 20 includes four armature windings 28, which would also be positioned around the periphery of the receptacle cavity 32, the lamp engaging therein. The lamp receptacle 30 and receptacle cavity 32 are best shown in FIGS. 1B, 2-4, and 6-7.

In the drawings and specification, there have been disclosed a typical preferred embodiment of the invention, and although specific terms are employed, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification and as defined in the appended claims.

That which is claimed:

1. A ballast for a fluorescent lamp, comprising:
a housing having an upper end, a lower end, and a side periphery extending therebetween;
a threaded base extending from the lower end of said housing and comprising a plurality of base electrical contacts insulated from each other for connecting the ballast to a complementary source of electrical power;
a plurality of armature windings connected in series to said plurality of base electrical contacts to thereby provide voltage and current sufficient for heating electrodes in the fluorescent lamp when said lamp is electrically connected to said ballast; and
a lamp receptacle formed at the upper end of said housing and including a plurality of receptacle contacts connected to said plurality of armature windings and to said plurality of base electrical contacts so as to complete an electrical circuit with a fluorescent lamp engaged in said lamp receptacle, said lamp receptacle having a receptacle cavity extending into the housing from the upper end toward the lower end, and having said plurality of armature windings positioned about a periphery of the receptacle cavity to thereby provide compactness to said ballast.

2. A method of connecting a fluorescent lamp to a ballast, comprising:
configuring the ballast to have a housing, a threaded base extending from a lower end of the housing and comprising a plurality of base electrical contacts insulated from each other for connecting the ballast to a complementary source of electrical power, a plurality of armature windings connected in series to the plurality of base electrical contacts to thereby provide voltage and current sufficient for heating electrodes in the fluorescent lamp when the lamp is electrically connected to the ballast, and a lamp receptacle formed at the upper end of the housing and including a plurality of receptacle contacts connected to the plurality of armature windings and to the plurality of base electrical contacts so as to complete an electrical circuit when a fluorescent lamp is engaged in the lamp receptacle, the lamp receptacle having a receptacle cavity extending into the housing from the upper end toward the lower end, and having the plurality of armature windings positioned about a periphery of the receptacle cavity to thereby provide compactness to said ballast; and
connecting the fluorescent lamp into the lamp receptacle so that the plurality of armature windings surrounds the receptacle cavity.
